(19) United States
(12) Patent Application Publication
(10) Pub. No.: US 2012/0026131 A1
(43) Pub. Date: Feb. 2, 2012

(54) REDUCING NOISE SUSCEPTIBILITY IN A MUTUAL CAPACITANCE TOUCHPAD THROUGH AXIS SWAPPING

(76) Inventors: Jared G. Bytheway, Sandy, UT (US); Paul Vincent, Kaysville, UT (US)

(21) Appl. No.: 13/193,457

(22) Filed: Jul. 28, 2011

Related U.S. Application Data
(60) Provisional application No. 61/368,494, filed on Jul. 28, 2010.

(51) Int. Cl. G06F 3/044

(52) U.S. Cl. 345/174

(57) ABSTRACT

A system and method for reducing noise on a touchpad that uses mutual capacitance on an X axis and Y axis grid of transverse electrodes that function as stimulus or drive electrodes on one axis and function as inputs or sense electrodes on a different axis, wherein there is significant noise that can affect operation of the touchpad, and wherein it is desirable to minimize the effects of this noise by simultaneously sampling a group of sense electrodes, wherein by sampling the sense electrodes at the same time, the level of noise on each sense electrode should be similar and can therefore be subtracted out of measured sense signals to therefore more accurately determine a position of a sensed object or objects on the touchpad.

### CROSS REFERENCE TO RELATED APPLICATIONS

This document claims priority to and incorporates by reference all of the subject matter included in the provisional patent application docket number 4835.CIRQ.PR, having Ser. No. 61/368,494.

### BACKGROUND OF THE INVENTION

1. Field of the Invention

This invention relates generally to touch sensitive devices including touchpads and touch screens. More specifically, the present invention is a method of reducing noise in a mutual capacitance touch sensitive device that uses a transverse grid of X and Y electrodes in the sensors.

2. Description of Related Art

There are several designs for capacitance sensitive touchpads. One of the existing touchpad designs that can be modified to work with the present invention is a touchpad made by CIRQUE® Corporation. Accordingly, it is useful to examine the underlying technology to better understand how any capacitance sensitive touchpad can be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes that are disposed in a same plane but crosswise or transverse to each other, and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and, Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in, a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row-electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing. Either design will enable the present invention to function.

It should be understood that a touchpad and touch screen are defined as touch sensitive devices as used in this document. Accordingly, any touch sensitive device will be referred to hereinafter as a touchpad, but should be considered to include any type of touch sensitive device using any type of touch input technology, and should not be considered to be limited to mutual capacitance technology, touchpads or touch screens.

An even earlier CIRQUE® Corporation mutual capacitance touchpad technology does not use the dedicated Sense line in order to receive signals that indicate the presence or location of an object. In this earlier technology that is described in U.S. Pat. No. 5,305,017 and in U.S. Pat. No. 5,565,658 among others, one set of electrodes (such as the X electrodes) are drive electrodes, and the Y electrodes are the sense electrodes. The function of the X axis and Y axis electrodes (referred to hereinafter as X and Y electrodes) is reversed as needed. Thus in one set of measurements the X electrodes can function as drive electrodes and the Y electrodes function as sense electrodes, and in a different set of measurements the roles are reversed and the X electrodes function as sense electrodes and the Y electrodes function as drive electrodes.

Accordingly, it would be an improvement over the prior art to provide a system and method for reducing the noise of a mutual capacitance touchpad that does not use a dedicated sense electrode, but only the X and Y electrodes that can switch between the functions of driving and receiving signals on touchpad circuitry.

### BRIEF SUMMARY OF THE INVENTION

In a first embodiment, the present invention is a system and method for reducing noise on a touchpad that uses mutual capacitance on an X axis and Y axis grid of transverse electrodes that function as stimulus or drive electrodes on one axis and function as inputs or sense electrodes on a different axis, wherein there is significant noise that can affect operation of the touchpad, and wherein it is desirable to minimize the effects of this noise by simultaneously sampling a group of sense electrodes, wherein by sampling the sense electrodes at the same time, the level of noise on each sense electrode should be similar and can therefore be subtracted out of measured sense signals to therefore more accurately determine a position of a sensed object or objects on the touchpad.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of operation of a first embodiment of a touchpad that is found in the prior art, and which is adaptable for use in the present invention.

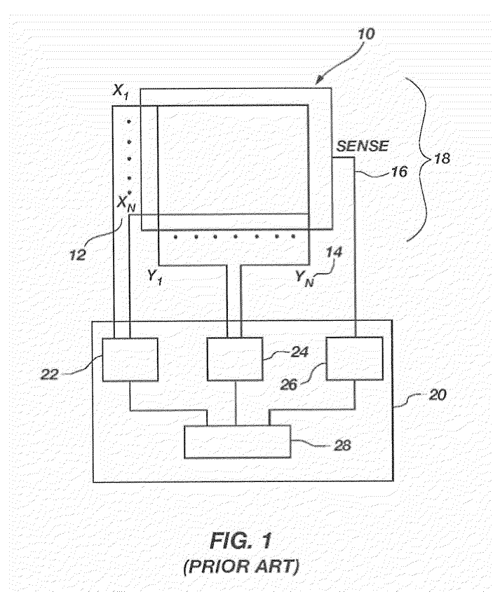

FIG. 2 is a block diagram showing that a touchpad is coupled to X and Y electrodes to both a stimulus source and to a sensing input, but only one axis at a time.

FIG. 3 shows a mutual capacitance sensor with drive electrodes in one axis and sense electrodes in the other axis.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

This invention applies to touchpads that use mutual capacitance in an X and Y grid of transverse electrodes wherein the stimulus or drive electrodes are on one axis and the inputs or sense electrodes are on the other axis. When there is significant noise on the finger or in the system compared to the finger, it is desirable to minimize the effects of this noise by sampling all or a significant number of sensing channels (sense electrodes) at the same time. If the sense electrodes are sampled at the same time, the level of noise on each sense electrode should be similar and can therefore be subtracted out of the measured signals, thereby improving accuracy of the position being determined for the object or objects on the touchpad.

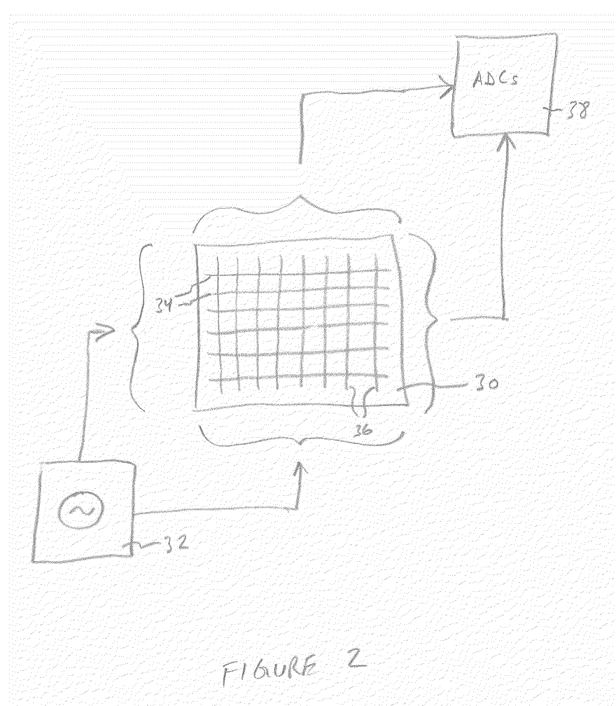

FIG. 2 is provided as a block diagram of the essential features of the present invention. In a first embodiment, a touchpad grid 30 is shown coupled to a stimulus source 32 for generating signals that are used to stimulate the drive electrodes on the touchpad grid. As shown, the drive electrodes can be the row or X electrodes 34, or they can be the column or Y electrodes 36.

The touchpad grid 30 is also shown as being coupled to analog-to-digital converters (ADCs) 36 which receive as input the signals from the touchpad grid 30. As shown, the sense electrodes can be the row or X electrodes 34, or they can be the column or Y electrodes 36.

What is important to note is that only one axis, either X or Y, can function as the drive electrodes at a time. Similarly, the other axis electrodes must therefore function as the sense electrodes at that time. What is important in the present invention is that those roles can be switched as needed. Thus, when the X electrodes 34 function as the drive electrodes, the Y electrodes 36 function as the sense electrodes.

It is known to those skilled in the art of touchpads that the X and Y electrodes 34, 36 can switch in function. However, it is common practice for the position of a finger to be determined using a single set of measurements. In other words, it is common for the X and Y position of a finger to be determined using a single set of measurements. For example, the measurements from the sense electrodes can be used to determine the location of a finger in both the X and Y coordinate axes using stimulus from the drive electrodes when the stimulus electrodes are the X electrodes 34 and the drive electrodes are the Y electrodes 36. Likewise, the single set of measurements could come from the situation wherein the stimulus electrodes are the Y electrodes 36 and the drive electrodes are the X electrodes 34.

The present invention is the ability to reduce noise susceptibility of the touchpad by requiring the taking of two sets of measurements to determine finger position. Specifically, the position of the finger is determined in only one axis at a time. The position is determined from whichever axis is functioning as the stimulus electrodes. Thus, if the X electrodes are functioning as the drive electrodes, then position information is only determined in the Y axis because the Y electrodes are functioning as the stimulus electrodes. Then, the next step would be to switch the function of the X electrodes 34 and the Y electrodes 36 in order to determine the position of the finger in the X axis because the X electrodes are now functioning as the stimulus electrodes.

In a first embodiment, the present invention thus provides a co-planar grid of X axis and Y axis electrodes disposed in a transverse arrangement to form a touchpad grid 30. The touchpad circuitry includes all the circuits necessary to stimulate the touchpad grid 30, receives the signals therefrom and from that information determines the location of a finger making contact with the touchpad grid 30.

The ADCs 38 are coupled to other touchpad circuitry that takes the measurement information and determines finger position. It should be understood that the touchpad of this first embodiment is a mutual capacitance sensing device that detects a decrease in mutual capacitance between the drive and sense electrodes when a finger is in contact with the touchpad. The mutual capacitance capabilities also mean that the present invention is capable of detecting and tracking the location of multiple fingers on the touchpad at the same time.

The touchpad circuitry selects the electrodes of the X axis or the Y axis to function as the drive electrode and the other axis to function as the sense electrodes, and then stimulate at least one drive electrode with an appropriate signal. The drive electrodes can be stimulated one at a time or in any combination up to all being stimulated simultaneously.

What is important is that more than one of the sense electrodes can be measured simultaneously. This is important because in order to subtract noise from the sense electrodes, the noise is assumed to be present on all of the sense electrodes being measured. Thus, all of the sense electrodes could be measured simultaneously and the noise could be eliminated from the signals. However, having an ADC 38 coupled to every sense electrode makes the touchpad circuitry more expensive. Therefore, an effective method of reducing the overall cost of a touchpad is to use a limited number of ADCs 38. For example, a CIRQUE® Corporation touchpad uses four ADCs 38 in a typical configuration.

A finger will typically not affect more than four sense electrodes at a time. Therefore, in this embodiment, four ADCs 38 are being used in the formulas for determining location position of the finger. It should be understood that a larger or smaller number of ADCs 38 can be used and still be within the scope of the claims of the present invention. But this limitation of four is an example only, and should not be considered to be a limiting factor of the claims.

The present invention can determine which sense electrodes are being affected by the presence of the finger and use the ADCs 38 that can be coupled to those sense electrodes to calculate the position of the finger. The method of determining which sense electrodes are being affected is not a limitation of the present invention.

After the sense electrodes are identified, the position of the finger is determined using various calculations that are known to those skilled in the art. What is important is that those calculations are able to eliminate the noise that is assumed to be present and therefore being measured on all the sense electrodes. An example of these a method that can be used is a weighted sum calculation which will be demonstrated in this document.

What is essential at this step is that the position of the finger is only determined in the axis which is functioning as the sense electrodes. After the position is determined, the functions of the X and Y electrodes are swapped. For this is example it will be assumed that the Y electrodes 34 were functioning, as the sense electrodes and the position for the finger was therefore determined in the Y axis.

The method then proceeds as before where it is determined which of the new sense electrodes are now being affected by the finger. After finding the affected electrodes, measurements are taken by the ADCs 38 from the new sense electrodes, and the position of the finger is now determined in the X axis.

A first method presented in this first embodiment for determining finger position is a weighted sum calculation. This method is simple and accurate and illustrates the aspect of being able to eliminate noise from the measurements.

The following variables are defined herein:
S=signal from the sense electrodes
Ax=area common to the finger and given sense electrode
N=noise from the finger (or system)
Kx=percent deviation of finger to sense electrode vs finger's influence on mutual capacitance change
Mx=measurement for a given ADC
Ma=Aa(S+KaN)
Mb=Ab (S+KbN)
Mc=Ac (S+KcN)
Md=Ad(S+KdN)
Wx=Mx*electrode number, the weighted sum
Px=electrode number
Wa=Ma*Pn
Wb=Mb*Pn+1
Wc=MC*Pn+2
Wc=Md*Pn+2

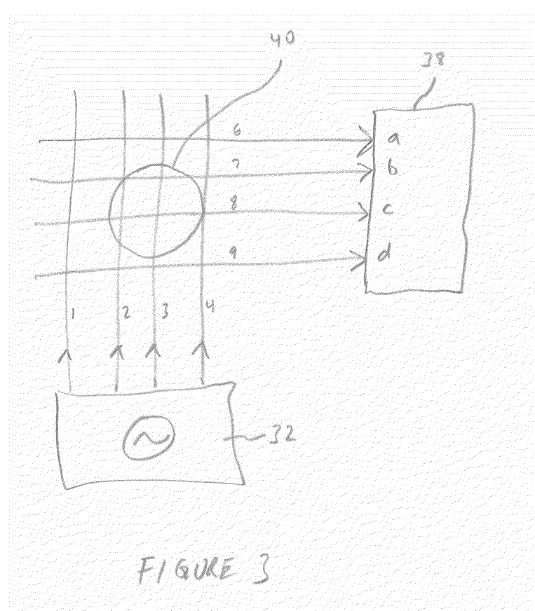

FIG. 3 is provided as an example of how four ADCs 38 can be used to determine the location of a finger 40 on a touchpad using the weighted sum method. Only four X electrodes (electrodes 6 through 9) 32 and four Y electrodes (electrodes 1 through 4) 34 are shown from a larger touchpad comprised of a greater number of X and Y electrodes. For this example, Pn=which gives:

Wa=Ma*6

Wb=Mb*7

Wc=Mc*8

Wd=Md*9

The position equation for the finger in a single axis is given as follows:

Position=(Wa+Wb+Wc+Wd)/(Ma+Mb+Mc+Md) Equation 1

Substituting in values, equation 1 is expanded as shown as follows:

$$Position = \frac{\begin{matrix}( S + {K}_{n} N ) {A}_{a} {P}_{n} + ( S + {K}_{n + 1} N ) {A}_{b} {P}_{n + 1} + \\ ( S + {K}_{n + 2} N ) {A}_{c} {P}_{n + 2} + ( S + {K}_{n + 2} N ) {A}_{d} {P}_{n + 2}\end{matrix}}{\begin{matrix}( S + {K}_{n} N ) {A}_{a} + ( S + {K}_{n + 1} N ) {A}_{b} + \\ ( S + {K}_{n + 2} N ) {A}_{c} + ( S + {K}_{n + 2} N ) {A}_{d}\end{matrix}} \qquad Equation 2$$

If it is assumed that the noise from the finger couples to the sense electrodes at the same rate as the finger's influence on mutual capacitance, (Kx=Kx+1) then it is possible to factor out S and N as shown in equation 3.

$$Position = \frac{( S + {K}_{x} N ) I ( {AI}_{a} {P}_{n} + {A}_{b} {P}_{n + 1} + {A}_{c} {P}_{n + 2} + {A}_{d} {P}_{n + 3} )}{( S + {K}_{x} N ) I ( {AI}_{c} + {A}_{b} + {A}_{c} + {A}_{d} )} \qquad Equation 3$$

Equation 3 can be reduced by crossing out (S+K×N) which completely cancels out noise and signal strength. This means that position is independent of noise and signal strength.

In practical systems, however, Kx is not equal to Kx+1. The amount of coupling from the finger to a sense electrode is based on common area and is slightly different than the finger's area effect on mutual capacitance. The sensor pattern can be optimized to maximize the similarity between the finger's coupling to the sense electrodes and the finger's affect on drive electrodes to sense electrodes.

This method works well for reducing noise in the sensing axis, but determining position in the driving axis remains susceptible to noise. That is why the present invention makes two measurements and only uses those measurements that are obtained from the sense electrodes and not from the axis of the drive electrodes.

It is also observed that a common method to determining position in the drive electrode axis is to stimulate fewer drive electrodes than the width of the finger. The next step would be to then take another measurement where the stimulus is shifted and look the signal strength in the sense electrode axis. This works fine when there is no noise in the system or the finger. However when there is noise, each measurement could have a different amount of noise thus varying the sense electrodes overall level for each drive electrode stimulus pattern. If the sense electrodes vary every measurement, it is extremely difficult to determine position in the drive electrode axis.

This invention is electrically swapping the drive electrode axis with the sense electrode axis to provide improved position data in the second axis. Specifically, the electrodes that were sense electrodes in the first case are drive electrodes in the second case and electrodes that were drive electrodes in the first case are sense electrodes in the second case. This results in greatly improved noise immune finger position reporting.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for reducing the susceptibility of a touch sensitive device to noise, said method comprising the steps of:
1) providing a co-planar grid of X axis and Y axis electrodes disposed in a transverse arrangement;
2) providing mutual capacitance sensing touchpad circuitry that is coupled to the grid of X axis and Y axis electrodes, wherein the touch sensitive circuitry provides stimulus signals to the drive electrodes and receives signals from the sense electrodes and detects a decrease in mutual capacitance between the drive and sense electrodes when a finger is in contact with the touch sensitive device;
3) selecting the electrodes of the X axis or the Y axis to function as the drive electrodes and the other axis to function as the sense electrodes;
4) stimulating at least one drive electrode with an appropriate signal, and sampling signals from the sense electrodes;
5) determining a position of the finger only in the axis that is functioning as the sense electrodes, wherein position is determined using a method that is independent of the strength of the noise and the signal on the sense electrodes;
6) swapping the functions of the X axis and Y axis electrodes so that the axis functioning as the drive electrodes is now functioning as the sense electrodes, and vice versa; and
7) repeating step 5) to determine the position of the finger in the axis now functioning as the sense electrodes, thereby determining position information of the finger using data that is only collected from the X axis and the Y axis when they are functioning as the sense electrodes.

2. The method as defined in claim 1 wherein the step sampling signals from the sense electrodes further comprises the step of simultaneously sampling all of the sense electrodes to thereby collect data that is affected by the same noise.

3. The method as defined in claim 1 wherein the step of sampling signals from the sense electrodes further comprises the step of only using data from sense electrodes that are affected by the finger, and wherein the data is collected simultaneously from the affected sense electrodes so that the sense electrodes are all affected by the same noise.

4. The method as defined in claim 3 wherein the method further comprises the steps of:
1) determining which sense electrodes are affected by the finger; and
2) using measurements from analog-to-digital converters (ADCs) that are only coupled to the sense electrodes affected by the finger.

5. The method as defined in claim 1 wherein the step of determining a position of the finger using a method that is independent of the strength of the noise and the signal on the sense electrodes further comprises the step of using a weighted sum calculation.

6. The method as defined in claim 1 wherein the method further comprises the step of repeating steps 3) through 7) for each finger that is detected by the touch sensitive circuitry.

7. The method as defined in claim 1 wherein the method further comprises the step of selecting the touch sensitive device from the group of touch sensitive devices comprised of touchpads and touch screens.

8. A method for reducing the susceptibility of a mutual capacitive touch sensitive device to noise when detecting the presence of a plurality of fingers on the touch sensitive device, said method comprising the steps of:
1) providing a co-planar grid of X axis and Y axis electrodes disposed in a transverse arrangement;
2) providing mutual capacitance sensing touchpad circuitry that is coupled to the grid of X axis and Y axis electrodes, wherein the touch sensitive circuitry provides stimulus signals to the drive electrodes and receives signals from the sense electrodes and detects a decrease in mutual capacitance between the drive and sense electrodes when a plurality of fingers are in contact with the touch sensitive device;
3) selecting the electrodes of the X axis or the Y axis to function as the drive electrodes and the other axis to function as the sense electrodes;
4) making contact with the touch sensitive surface using a plurality of fingers;
5) stimulating at least one drive electrode with an appropriate signal, and sampling signals from the sense electrodes;
6) determining a position of each of the plurality of fingers only in the axis that is functioning as the sense electrodes, wherein position is determined using a method that is independent of the strength of the noise and the signal on the sense electrodes;
8) swapping the functions of the X axis and Y axis electrodes so that the axis functioning as the drive electrodes, is now functioning as the sense electrodes, and vice versa; and
9) repeating step 6) to determine the position of each of the plurality of fingers in the axis now functioning as the sense electrodes, thereby determining position information of each of the plurality of fingers using data that is only collected from the X axis and the Y axis when they are functioning as the sense electrodes.

9. The method as defined in claim 8 wherein the step of sampling signals from the sense electrodes further comprises the step of simultaneously sampling all of the sense electrodes to thereby collect data that is affected by the same noise.

10. The method as defined in claim 8 wherein the step of sampling signals from the sense electrodes further comprises the step of only using data from sense electrodes that are affected by the plurality of fingers, and wherein the data is collected simultaneously from the affected sense electrodes so that the sense electrodes are all affected by the same noise.

11. The method as defined in claim 10 wherein the method further comprises the steps of:
1) determining which sense electrodes are affected by the plurality of fingers; and
2) using measurements from analog-to-digital converters (ADCs) that are only coupled to the sense electrodes affected by the plurality of fingers.

12. The method as defined in claim 8 wherein the step of determining a position of the plurality of fingers using a method that is independent of the strength of the noise and the signal on the sense electrodes further comprises the step of using a weighted sum calculation.

13. The method as defined in claim 8 wherein the method further comprises the step of repeating steps 3) through 7) for each finger that is detected by the touch sensitive circuitry.

14. The method as defined in claim 8 wherein the method further comprises the step of selecting the touch sensitive device from the group of touch sensitive devices comprised of touchpads and touch screens.
